(19) United States
(12) Patent Application Publication
(10) Pub. No.: US 2004/0066920 A1
(43) Pub. Date: Apr. 8, 2004

(54) Method and apparatus for automatically populating a contact database in a mobile communication device

(76) Inventor: Tom R. Vandermeijden, Pacifica, CA (US)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 09/945,072

(22) Filed: Aug. 31, 2001

(51) Int. Cl. H04M 1/64; H04M 3/42

(52) U.S. Cl. 379/88.19; 455/414.1

(57) ABSTRACT

A method and apparatus for automatically populating a contact database in a mobile communication device configured to communicate voice and data over a wireless network are described. A telephone number associated with an incoming or outgoing voice call involving the mobile communication device is received by a browser in the mobile communication device. When a data connection is established between the mobile communication device and a remote processing system via the wireless network, the browser automatically obtains data associated with the telephone number from a remote processing system via the wireless network and stores the data in the contact database in association with the telephone number.

### FIELD OF THE INVENTION

The present invention pertains to mobile telephones and other wireless communication devices. More particularly, the present invention relates to a method and apparatus for using Caller-ID information in a browser of a mobile telephone or other wireless communication device.

### BACKGROUND OF THE INVENTION

Wireless telecommunications is the technology upon which cellular telephones and many other commonly used mobile communications and computing devices are based. This technology has undergone rapidly advancements in recent years and has been adopted worldwide with unprecedented speed. Cellular telephony in particular has the benefit of allowing people to communicate with each other from virtually any location.

Many mobile telephones include a contact database, e.g., an address book, to store names, telephone numbers, and addresses of individuals and businesses with whom the user frequently communicates. This feature generally has no value unless the user enters or downloads his contact information. However, a significant number of wireless telephone users do not use this feature, because they are unable or unwilling to enter or download their contact data. For some users, doing so is simply too much of an inconvenience. Others have difficulty learning how to operate this feature of the device. Accordingly, there is a need for a more user-friendly method of populating a contact database in a mobile telephone or other mobile device.

### SUMMARY OF THE INVENTION

The present invention includes a method and apparatus for automatically populating a contact database in a mobile communication device configured to communicate voice and data over a wireless network. In the method, a telephone number associated with a voice call involving the mobile communication device is received. When a data connection is established between the mobile communication device and a remote processing system via the wireless network, data associated with the telephone number is automatically obtained via the wireless network and stored in the contact database in association with the telephone number.

Other features and advantages of the present invention will be apparent from the accompanying drawings and from the detailed description which follows.

### BRIEF DESCRIPTION OF THE DRAWINGS

The present invention is illustrated by way of example and not limitation in the figures of the accompanying drawings, in which like references indicate similar elements and in which:

FIG. 1 shows a network environment in which the present invention can be implemented;

FIG. 2 is a high-level block diagram of a wireless handset;

FIG. 3 is a flow diagram showing a process performed by a telephony unit of the wireless handset based on Caller-ID information;

FIG. 4 is a flow diagram showing a process performed by the telephony unit to output a distinctive ring tone based on Caller-ID data;

FIG. 5 is a flow diagram showing a browser process for identifying and, if appropriate, performing, an action associated with Caller-ID information;

FIGS. 6A and 6B collectively are a flow diagram showing a browser process for identifying distinctive ring tone data associated with Caller-ID information;

FIG. 7 is a flow diagram showing a browser process of requesting data associated with Caller-ID information from a remote server;

FIGS. 8A and 8B show browser processes for automatically populating a contact database in a mobile device, based on a telephone number in an incoming or outgoing telephone call; and

FIG. 9 is a high-level block diagram of a processing system representative of any of the processing devices or systems shown in FIG. 1.

### DETAILED DESCRIPTION

A method and apparatus for automatically populating a contact database in a mobile communication device are described. Note that in this description, references to “one embodiment” or “an embodiment” mean that the feature being referred to is included in at least one embodiment of the present invention. Further, separate references to “one embodiment” in this description do not necessarily refer to the same embodiment; however, neither are such embodiments mutually exclusive, unless so stated and except as will be readily apparent to those skilled in the art. For example, a feature, structure, act, etc. described in one embodiment may also be included in other embodiments. Thus, the present invention can include a variety of combinations and/or integrations of the embodiments described herein.

The technique described herein can be applied to increase the usefulness of a mobile telephone and to better protect the privacy of its user. Among other applications, by allowing distinctive ring tones to be associated with particular callers or groups of callers, based on Caller-ID information, the present invention makes it easier for the user to identify a caller. In addition, the present invention provides a technique which allows a user's contact database to be incrementally and automatically populated each time the user places or receives a call using the wireless handset. This technique makes the contact database of a wireless handset more usable for those users who are unable or unwilling to enter or download their contact data into the contact database.

As described further below, in one embodiment a mobile telephone includes a telephony unit to process telephony signals and a browser to enable the user to access and navigate hyperlinked (“hypermedia”) information stored on a remote data network, such as the Internet, via a wireless network. When the telephony unit receives a signal indicating an incoming telephone call along with Caller-ID information, instead of immediately ringing the telephone, the telephony unit activates the browser and passes the Caller-ID information to the browser.

The browser uses the Caller-ID information to identify an action or data of a predetermined type, previously associated with that specific Caller-ID information. The data or an indication of the action may be stored in the user's contact database (“address book”) within the mobile telephone. One example of such data is ring tone data for generating a distinctive ring tone. One example of such an action is initiation of an outgoing telephone call. After the browser identifies the data or action associated with the Caller-ID information, the browser may use the data and/or may execute the action, if the browser is configured to do so. Otherwise, the browser may simply pass the data or indicate the action to the telephony unit, or any other unit in the mobile telephone that is responsible for using the data or executing the action. If the browser cannot locate the data locally within the mobile telephone, the browser attempts to obtain the data from a remote server over the wireless network.

Thus, in one embodiment, in response to receiving the Caller-ID information from the telephony unit, the browser looks up stored ring tone data previously associated with the telephone number of the incoming call and provides the ring tone data to the telephony unit. The telephony unit then causes a speaker on the mobile telephone to output a ring tone based on the ring tone data.

The ring tone data may be stored in the user's contact database in the mobile telephone. The contact database may be stored in the well-known vCard format, as defined by Internet Mail Consortium's (IMC) Requests for Comments (RFCs) 2425 and 2426, which are incorporated herein by reference, and which define vCard version 3.0. The vCard format is extensible and allows for the addition of database fields. The technique described herein calls for the addition of fields in the contact database to store ring tone data, uniform resource locator (URL) locations of ring tone data, and (optionally) a mute override flag. URLs are used to locate sets of ring tone data that exceed the maximum vCard size. Ring tone data may be encoded in any of various conventional forms for storing audio files, such as MP3 or .wav files.

The ring tone data may be downloaded from a remote ring tone server via the wireless network. In that case, distinctive ring tones may be assigned by either the user of the mobile telephone, potential callers (using, e.g., vCard extensions), or third parties. The ring tones may be stored on the ring tone server prior to a call and selected through a standard World Wide Web interface. The ring tone server may also provide a facility which allows mobile telephone users and potential callers to upload ring tone data to the ring tone server, for subsequent downloading and use in mobile telephones by themselves and others.

The user may wish to have a unique ring tone for each caller in his contact database and/or he may wish to organize certain callers into groups (e.g., family, friends, customers, vendors) for purposes of assigning ring tones. In one specific implementation, the user can assign a ring tone which sounds like a particular musical instrument for everyone in a particular group of callers; the user can further assign a different melody to each caller in that group. In that case, the browser inputs the received Caller-ID information to a melody synthesis algorithm, which generates a brief tune using the instrument sound assigned to the caller's group.

Numerous other variations upon this technique are possible, as will be apparent from the following description. For example, the technique can be used for purposes other than identifying and playing distinctive ring tones. In addition, it will be recognized that the described technique can be implemented advantageously in mobile devices other than mobile telephones, such as two-way pagers, personal digital assistants (PDAs), and other similar devices.

As is well-known, the Internet is a global network of computer systems that provides computer users with near real-time delivery of information on virtually any topic imaginable from a large number of sources. Common uses of the Internet include the exchange of electronic mail (e-mail) messages, instant messaging, and browsing the World Wide Web. In recent years, computer network technology and wireless telecommunications technology have begun to merge, such that newer-generation cellular telephones and other mobile devices are usable as entry points to the Internet.

Devices used to access the Internet (or intranets) generally have certain features in common, whether they sit on a desktop or are held in the palm of the hand. One such feature is that they may be used to display and navigate hyperlinked content, such as web pages from the World Wide Web. Devices with such capability include software known as a browser, which allows the user to access and navigate the hyperlinked content. In a mobile device, this software is sometimes referred to as a microbrowser or minibrowser, because the software consumes much less memory than a conventional PC browser. Nonetheless, this software is simply a particular type of browser and, thus, may be referred to simply as a browser.

To access web pages on the Internet, network servers and network personal computers (PCs) normally use standard web protocols and mark-up languages, such as hypertext transport protocol (HTTP) and hypertext markup language (HTML), respectively. Mobile devices, on the other hand, generally use wireless protocols such as wireless access protocol (WAP) or handheld device transport protocol (HDTP) and wireless markup languages such as wireless markup language (WML) and handheld device markup language (HDML) to accomplish similar tasks.

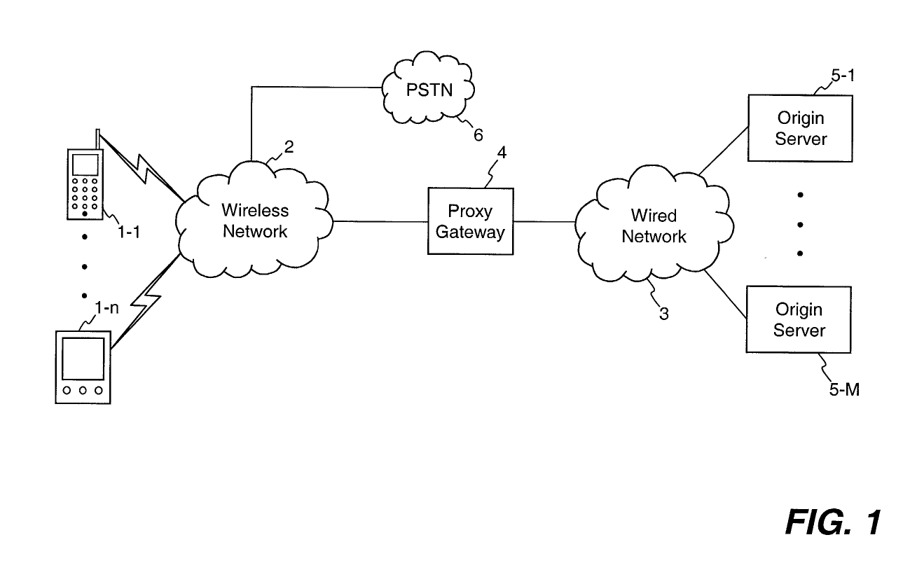

Refer now to FIG. 1, which shows a network environment in which the present invention can be implemented. A number (N) of mobile (“wireless”) devices 1-1 through 1-N operate on a wireless telecommunications network 2 (or simply “wireless network 2”). The wireless network may be, for example, a cellular digital packet data (CDPD) network, a global system for mobile (GSM) communications network, a time division multiple access (TDMA) network, a personal digital cellular (PDC) network, or a personal handy-phone system (PHS) network. Each of the wireless devices 1 may be, for example, any of: a cellular telephone, a personal digital assistant (PDA), a two-way pager, or any other hand-held, wireless communications/computing device. The wireless network 2 is coupled to the public switched telephone network (PSTN) 6. Hence, through the wireless network 2, the user of mobile telephone 1-1 can have telephonic communication with users of other mobile telephones and/or users of conventional wireline telephones on the PSTN 6.

The wireless network 2 is also coupled to a conventional wired computer network 3 through a proxy gateway 4. The wired network 3 may be, for example, the Internet, a campus intranet, a wide area network (WAN), a local area network (LAN), or a combination thereof. The proxy gateway 4 generally serves as a link between the wireless network 2 and the wired network 3. The proxy gateway 4 uses well-known techniques to enable communication between the wireless devices 1 and a number (M) of server processing systems (“servers”) 5-1 through 5-M operating on the wired network 3. The physical platforms which embody the proxy gateway 4 and servers 5 may include, for example, conventional server-class computer systems and/or personal computers (PCs). At least some of the servers 5 may be conventional web servers on the World Wide Web. Accordingly, servers 5 can provide content to the wireless devices 1 in response to requests from the wireless devices 1 and, in some cases, may “push” content to the mobile devices 1.

A proxy feature of proxy gateway 4 proxies requests and responses to requests between the wireless devices 1 and the servers 5. Some of the wireless devices 1 may not support the same protocols or languages used by the servers 5. For example, certain wireless devices 1 might support only wireless markup language (WML) and WAP, while the servers 5 use only hypertext markup language (HTML) or extensible mark-up language (XML) and HTTP. In such cases, a gateway feature of proxy gateway 4 converts/translates between the languages and protocols used by servers 5 and the languages and protocols used by the mobile devices 1 to allow these entities to communicate with each other.

Although the proxy gateway 4 is shown as a single network entity, the proxy and gateway functions can be distributed between two or more physical platforms. Furthermore, both functions may not be necessary in certain network implementations.

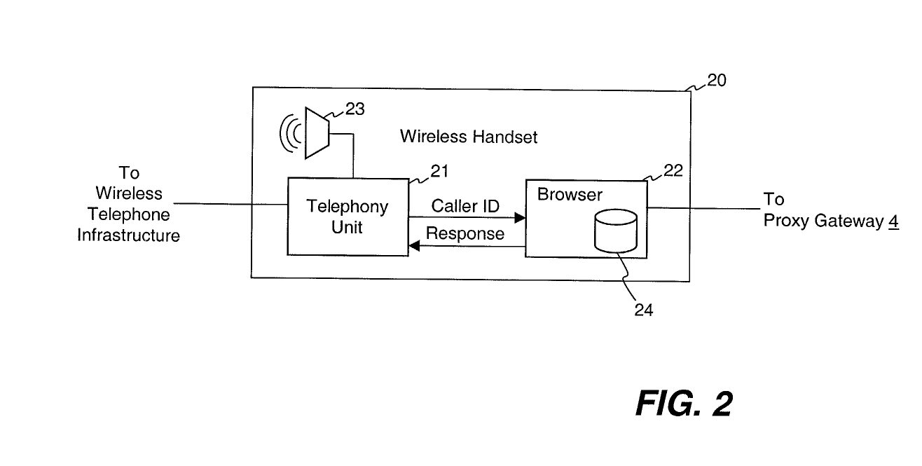

The following description focuses on a cellular telephone as an example of a wireless device 1, to facilitate description. However, the described techniques are also applicable to other types of mobile devices, as noted above. FIG. 2 shows an abstraction of a cellular telephone (hereinafter the “wireless handset”) 20. As shown, the wireless handset 20 includes a telephony unit 21 and a browser 22, operatively coupled to each other. The telephony unit 21 includes elements to allow real-time voice (telephonic) communication using the wireless handset 20. Thus, the telephony unit 21 provides the wireless handset 20 with an interface (via various RF circuitry and related components) to the telephone infrastructure of the wireless network 2. A description of the details of the telephony unit 21 is not necessary for an understanding of the present invention, and such details are familiar to those skilled in the relevant art.

The browser 22 enables the user of the wireless handset 20 to access and navigate hyperlinked information of various types stored in, for example, the servers 5 on the wired network 3. The browser 22 generally interfaces with the proxy gateway 4 (via various RF circuitry and related components) for purposes of accessing such information. The browser 22 may be a conventional browser designed for use in a cellular telephone or other wireless communication device, modified according to the techniques described herein. An example of such a browser is the Openwave Mobile Browser, which is available from Openwave Systems Inc. of Redwood City, Calif.

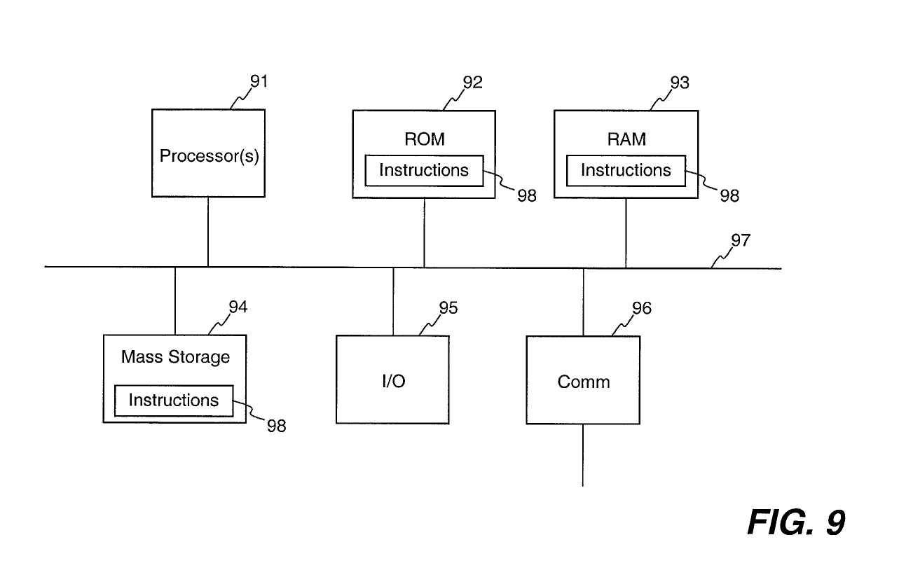

The telephony unit 21 and the browser 22 each may be hardware, software, or a combination of hardware and software. Furthermore, the telephony unit 21 and browser 22 may share certain elements, especially hardware elements. For purposes of further description, it is assumed that at least the browser 22 is software-based and that the telephony unit 21 is a combination of hardware and software. Thus, in one embodiment the hardware portion of the telephony unit 21 includes a processor, which is also the processor used to execute the browser 22. The composition of the wireless handset 20 is discussed further below in connection with FIG. 9. It is further assumed that the telephony unit 21 and the browser 22 communicate via application program interfaces (APIs).

As shown in FIG. 2, the browser includes a contact database (address book) 24 of the user. Alternatively, the contact database 24 may be stored within the wireless handset 20 separate from (but still accessible to) the browser 22.

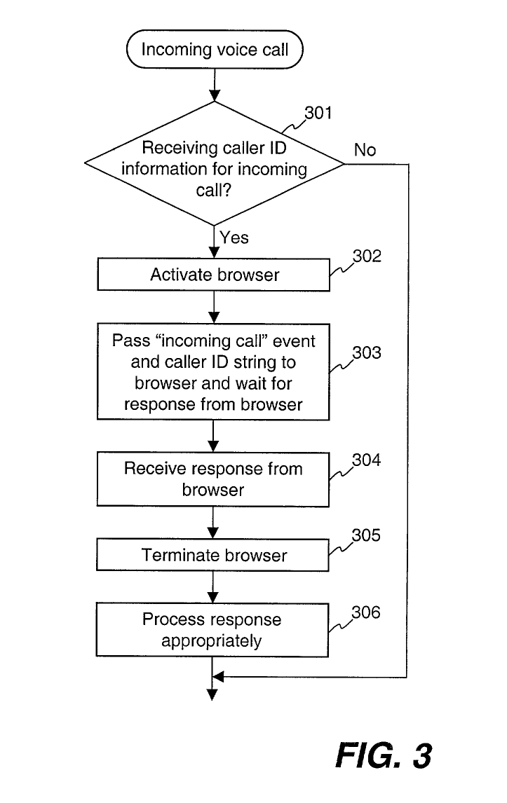

FIG. 3 shows a process that may be performed by the telephony unit 21 in response to receiving a signal indicating an incoming voice call, in accordance with the present invention. The entire process of FIG. 3 will generally take less than a second to execute and is completed before the user is even aware of the incoming call. In response to the signal, at block 301 the telephony unit 21 determines whether it is receiving Caller-ID information for the incoming call. As is well-known, Caller-ID information typically includes the telephone number and/or the name of the caller. Such information is referred to herein (individually or collectively) as the Caller-ID string. If no Caller-ID information is received, the process ends. If Caller-ID information is received, then instead of immediately ringing the telephone, the telephony unit 21 activates the browser 22 at block 302. At block 303, the telephony unit 21 passes an “incoming call” event and the Caller-ID string to the browser 22 and waits for a response from the browser 22. The telephony unit 21 receives a response from the browser 22 at block 304. In response, the telephony unit 21 terminates (deactivates) the browser 22 at block 305 and processes the response appropriately at block 306.

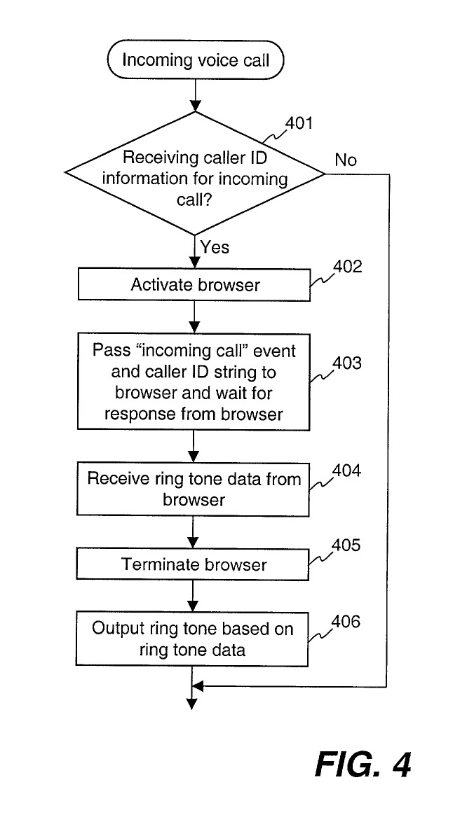

The content of the response and the specific manner in which it is processed will depend upon the implementation. One such implementation is described now with respect to FIG. 4. FIG. 4 shows a variation of the process of FIG. 3, for an embodiment which allows the use of distinctive ring tones for particular callers or groups of callers. As used herein, the term “ring tone” is defined as any sound designed to signal the existence of an incoming call to the user of the device receiving the call. A ring tone can be, for example, a recorded or synthesized musical melody, recorded or synthesized speech (e.g., recorded speech of the caller), or any other sound effect. Blocks 401 through 406 correspond to blocks 301 through 306 (described above), respectively. In block 404, however, the response from the browser includes ring tone data associated with the Caller-ID string, and in block 406 the telephony unit 21 processes the ring tone data by causing the speaker 23 of the wireless handset 20 to output a ring tone according to the ring tone data.

As noted above, in other embodiments the browser 22 may use the Caller-ID information to locate types of data other than ring tone data. The browser 22 may also use the Caller-ID information to identify (and if appropriate, execute) various types of actions previously associated with the Caller-ID information, such as signaling the telephony unit 21 to initiate an outgoing telephone call. For example, when an international call or other call involving toll charges is received, the predetermined action might include ignoring the incoming call and initiating an outgoing call to the telephone number in the Caller-ID information or a different telephone number previously specified by the user.

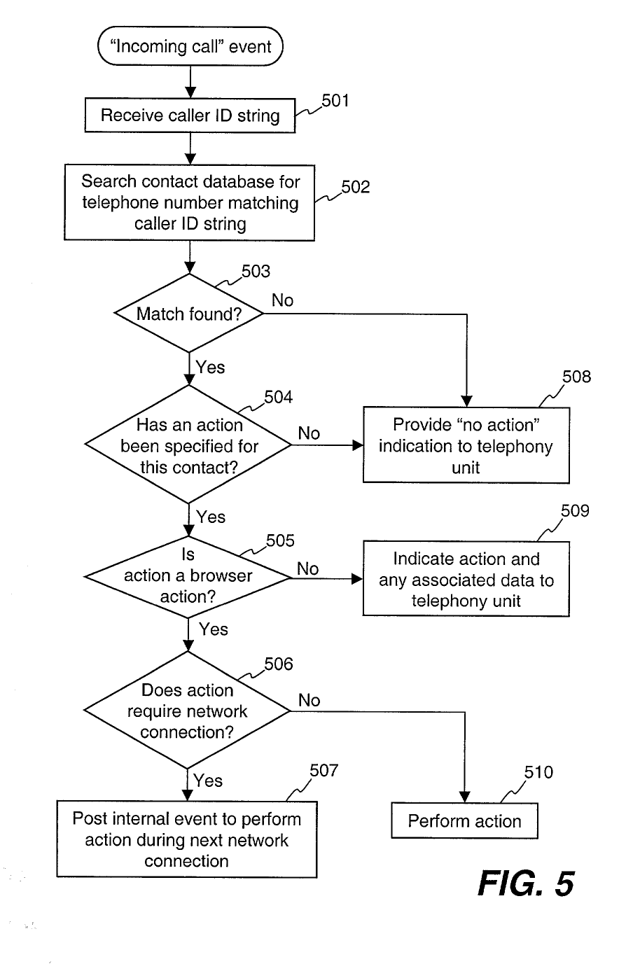

FIG. 5 is a flow diagram showing a browser process for identifying and, if appropriate, executing, an action previously associated with received Caller-ID information. In one embodiment, this process is implemented as a WML script in a WAP channel. After receiving an “incoming call” event from the telephony unit 21, the browser 22 receives the Caller-ID string at block 501. At block 502 the browser 22 searches the user's contact database 24 for a telephone number (or name) which matches the Caller-ID string. If no match is found, the process ends at block 508, in which the browser 22 returns a “no action” indication to the telephony unit 21. If the match is found, the browser 22 determines at block 504 whether an action has been specified for the contact database entry which matches the Caller-ID string. If no action has been specified, the process ends with block 508, as described above. If an action has been specified for this contact, then at block 505 the browser 22 determines whether the action is one which the browser 22 is capable of executing itself (“a browser action”). If the action is not a browser action, then the process ends at block 509, in which the browser 22 indicates the type of action and provides any associated data to the telephony unit 21 for further handling. If the action is a browser action, and if the action does not require a network connection (block 506), then the browser 22 executes the action at block 510, which ends the process. If the action does require network connection, then at block 507 the browser 22 posts an internal event to perform the action when a data connection is subsequently established over the wireless network. The next time a data connection is established may be, for example, wherein the user of the wireless handset 20 starts a browser session to access the Internet.

At the end of the process, the browser 22 is terminated, as indicated in block 305 of FIG. 3. Note that the browser 22 generally needs to be active for much less than a second to execute the entire process of FIG. 5.

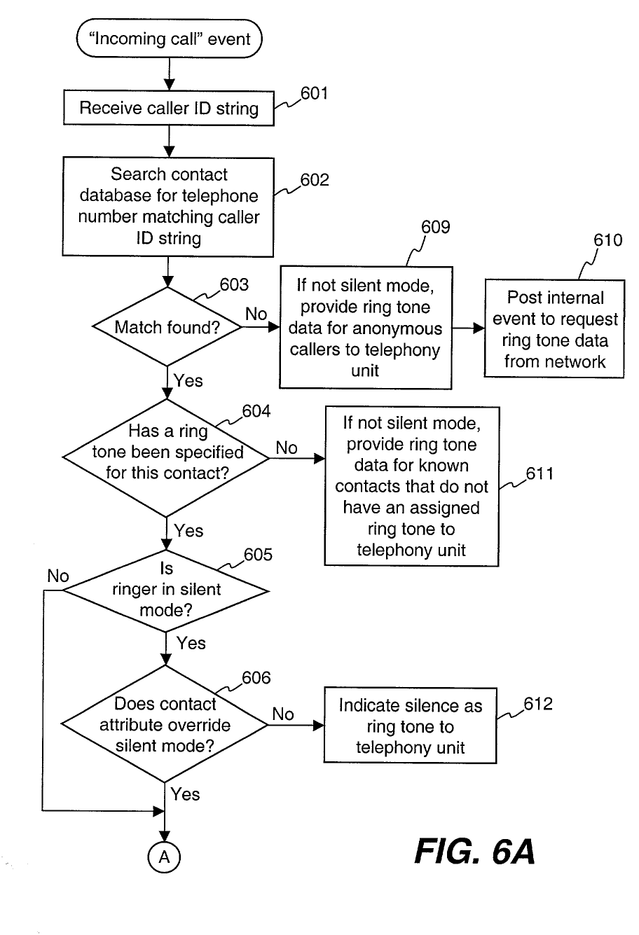

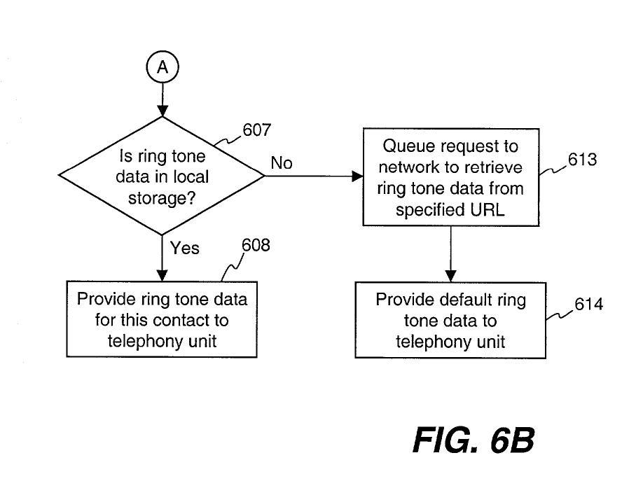

FIGS. 6A and 6B collectively illustrate a variation of the browser process of FIG. 5, to identify distinctive ring tone data associated with Caller-ID information. Blocks 601 through 603 are identical to blocks 501 through 503, respectively. If a match is found for the Caller-ID string in the contact database 24 at block 603, then the browser 22 determines if a ring tone has been specified for the contact at block 604. If a match is not found at block 603, then if the wireless handset 20 is not currently in silent mode, the browser 22 provides ring tone data previously specified for anonymous callers to the telephony unit 21 at block 609. Following block 609, at block 610 the browser 22 posts an internal event to request ring tone data from a remote ring tone server via the wireless network 2 the next time a data connection is established over the network. The handling of this internal event is described further below. This approach is based on the assumption that the incoming call signal is transmitted to the wireless handset before a voice or data channel is established, over a control channel that is unsuitable for communicating a significant amount of data (e.g., ring tone data), as in current telephony systems.

The remote ring tone server may be located using a URL, which may have been previously provisioned in the wireless handset 20. In one embodiment, the ring tone server is part of the proxy gateway 4. Alternatively, the ring tone server may be included in one of the servers 5 or any other processing system coupled (at least indirectly) to the wireless network 2. In any case, a negotiation may occur between the wireless handset 20 and the proxy gateway 4 so that the handset 20 will only be sent ring tone data of a type which it is capable of playing.

If a ring tone has not been specified for this contact (block 604), the process ends with block 611. In block 611, if the wireless handset is not in silent mode, the browser 22 provides to the telephony unit 21 ring tone data previously specified for known contacts that do not have an assigned ring tone. If a ring tone has been specified for this contact (block 604), then at block 605 the browser 22 determines whether the ringer is in silent mode. If the ringer is not in silent mode, the process jumps to block 607, described below. If the ringer is in silent mode, then at block 606 the browser 22 determines whether the matching contact has an attribute which overrides the silent mode.

The wireless handset 20 may have a ring silencer feature, which the user can activate when he does not want to be disturbed by telephone calls. However, there may be a few potential callers with whom the user would wish to speak even if they call when the ringer is silenced. Accordingly, a user-settable field or attribute (e.g., a flag) may be provided in the contact database 24, “break in”, to allow specified callers to break-through the silencer. As noted above, the contact database 24 may be stored in vCard format, which allows for the addition of fields.

Referring still to FIG. 6, if the matching contact does not have an attribute which overrides the silent mode, the browser 22 indicates silence as the ring tone to the telephony unit 21 at block 612. If the contact has an attribute which overrides the silent mode, the process continues from block 607, in which the browser 22 determines whether the ring tone data is stored locally within the wireless handset 20 (e.g., in the contact database 24). If the ring tone data is stored locally, the browser 22 provides the ring tone data for this contact to the telephony unit 21 at block 608. If the ring tone data is not stored locally, then at block 613 the browser 22 queues a network request to retrieve ring tone data from the remote ring tone server. Following block 613, the browser 22 provides default ring tone data for this contact to the telephony unit 21 at block 614. The queued request is then submitted over the wireless network 2 the next time a data connection is established over the wireless network 2.

The process of downloading the ring tone data from the ring tone server to the wireless handset 20 may be implemented using any of various conventional techniques. For example, ring tones may be downloaded according to the M-Services Guidelines promulgated by the Global System for Mobile Communications (GSM) Association, as defined in “M-Services Guidelines”, GSM Association Permanent Reference Document AA.35, version 3.0.0, May 31, 2001, which is incorporated herein by reference. As another example, ring tones may be provisioned in the wireless handset 20 using a provisioning technique described in co-pending U.S. patent application Ser. No. 09/289,559 of S. Dussee et al., filed on Apr. 9, 1999 and entitled, “Method and System Facilitating Web Based Provisioning of Two-Way Mobile Communications Devices”, which is incorporated herein by reference, and which is assigned to Openwave Systems Inc. of Redwood City, Calif.

In the above-described process, it is assumed that if ring tone data is not stored locally in the contact database 24, it is obtained via the wireless network 2 during a subsequent data connection. This approach is based on the assumption that the incoming call signal is transmitted to the wireless handset, before a voice or data channel is established, over a control channel that is unsuitable for communicating data (e.g., ring tone data), as in current telephony systems. Nonetheless, it is contemplated that future or alternative wireless network implementations may allow ring tone data to be sent to the wireless handset 20 over the wireless network 2 concurrently with an incoming call signal.

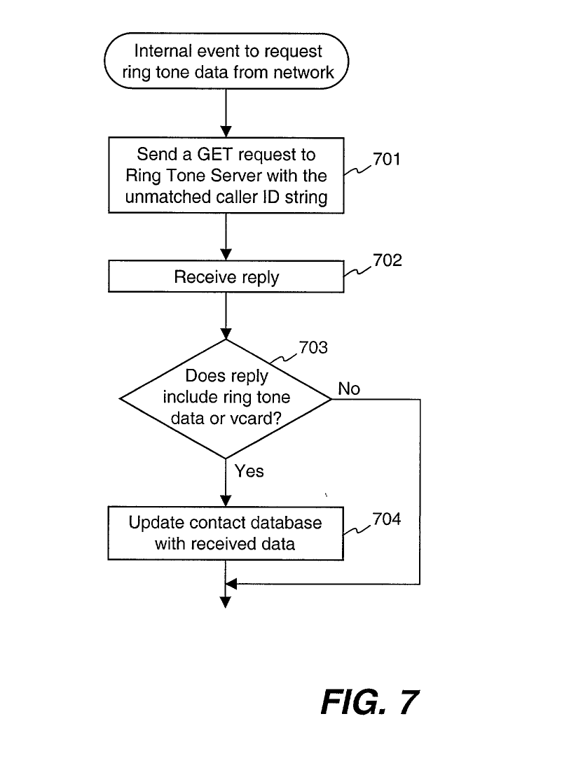

FIG. 7 shows a browser process of requesting data associated with Caller-ID information from a remote server (e.g., a ring tone server), and automatically updating the contact database 24 with the received data, such as may be done in response to the internal event of block 610. As noted, this process is performed when a data connection is established between the wireless handset 20 and a remote processing system over the wireless network 2. At block 701 the browser sends a standard HTTP GET request to the ring tone server with the unmatched Caller-ID string. The browser 22 receives a reply from the ring tone server at block 702. The reply may include the requested ring tone data. The ring tone data may included in a vCard. At block 703 the browser 22 determines whether the reply includes ring tone data and/or a vCard. If it does, the browser 22 updates the entry for this contact in the contact database 24 using the received ring tone data and/or vCard data. Otherwise, the process ends.

In other embodiments, the above-described technique may be extended to automatically update a local contact database in a wireless handset with types of data other than ring tone data, based on Caller-ID information associated with a telephone call. Furthermore, as will now be described, this process may be extended to automatically update a local contact database in response to Caller-ID information contained in outgoing telephone calls as well as incoming telephone calls.

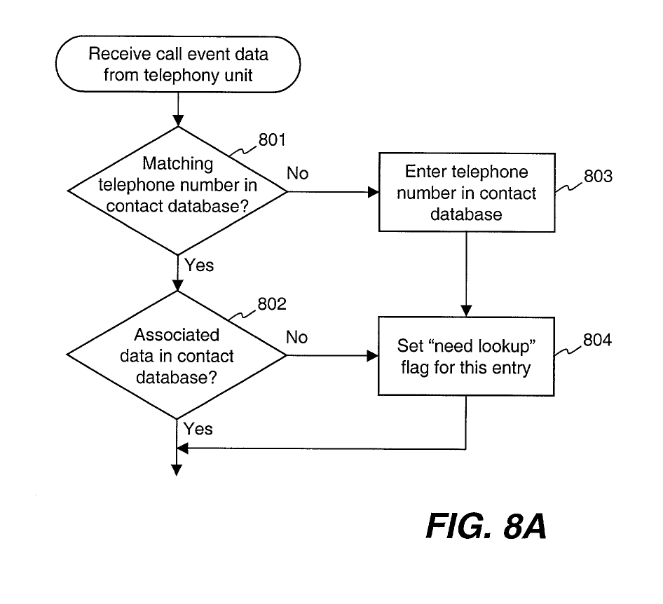

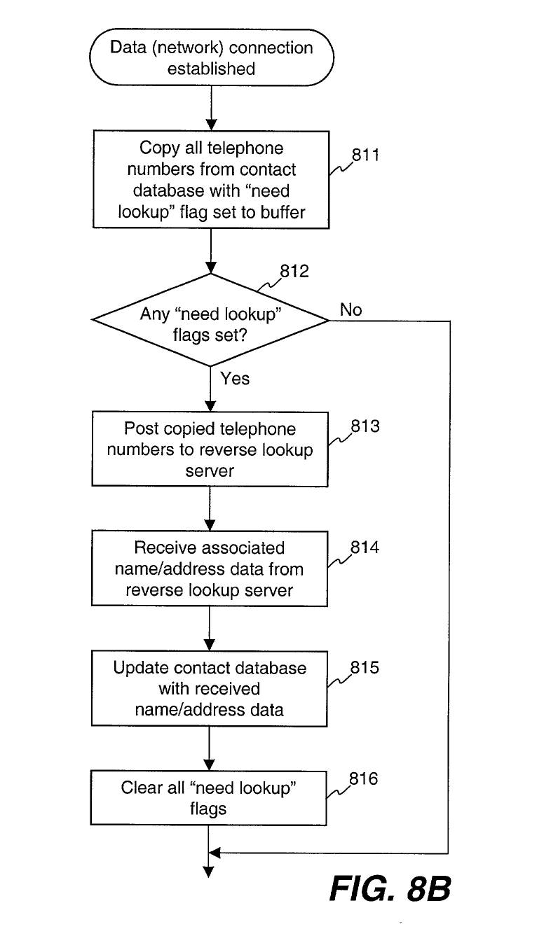

As noted above, many mobile device users do not use their contact databases, because they are unable or unwilling to enter or download their contact data. FIGS. 8A and 8B show browser processes that may be performed to automatically add name and address information (or other types of information) to a contact database in a wireless handset, based on Caller-ID information in either an incoming or an outgoing telephone call. These processes enable the user's contact database to be incrementally and automatically populated each time the user places or receives a call using the wireless handset. These processes, therefore, make the contact database of a wireless handset more usable for those users who are unable or unwilling to enter or download their contact data into the contact database. A populated contact database will tend to encourage these users to place more calls, increasing billable minutes before the wireless carrier. This technique will also benefit users who partially populate their contact databases manually and/or for automatic entry of data for subsequent contacts.

For each incoming or outgoing telephone call, the dialed telephone number is passed by the telephony unit 21 to the browser 22 as part of the call event data that indicates the telephone call to the browser 22. FIG. 8A shows a process performed by the browser 22 in response to receiving call event data representing either an incoming telephone call received by the wireless handset 20 or an outgoing telephone call placed by the user of the wireless handset 20.

The process is initiated when the browser 22 receives the call event data from the telephony unit 21. In response to the call event data, at block 801 the browser 22 determines whether the contact database 24 includes a telephone number matching the telephone number of the incoming or outgoing call. If the contact database 24 contains a matching telephone number, then at block 802 the browser 22 determines whether the contact database 24 includes data, such as a name or address, associated with the stored (matching) telephone number. If both blocks 801 and 802 are answered in the affirmative, the process ends. If, however, there is no matching telephone number in the contact database 24 (block 801), then at block 803 the browser 22 adds the telephone number of the incoming or outgoing call to the contact database 24 and then sets a “need lookup” flag for this contact entry, which ends the process. This state (flag) is saved at this time because it is assumed that a data (network) connection is not available, since a voice call is currently being attempted. If the contact database 24 includes a matching telephone number (block 801) but no associated data, the browser 22 sets the “need lookup” flag for this contact entry at block 804, and the process ends.

When the browser 22 is active and a data connection has been established via the wireless network 2, the browser 22 has an opportunity to find any data which is missing from the contact database 24. Accordingly, FIG. 8B shows a process by which the browser 22 automatically updates the contact database 24 when it is active and a data connection has been established. At block 811 the browser 22 copies into a buffer all telephone numbers in the contact database 24 for which the “need look up” flag has been set. If no “need lookup” flag is found to have been set at block 812, the process ends. If one or more “need lookup” flags are found to have been set at block 812, then the process proceeds with block 813, in which the browser 22 posts any telephone numbers in the buffer to a remote reverse lookup or vCard database server. The database server may be one of the servers 5 or any other processing system coupled (at least indirectly) to the wireless network 2. An example of a reverse lookup database server is the “555-1212.com” service provided at the Web site having the URL, “http://www.555-1212.com”. Alternatively, the database server may be part of the proxy gateway 4.

Next, at block 814 the browser 22 receives the associated name and/or address data from the database server via the wireless network 2. The browser 22 then adds the received data to the contact database 24 at block 815. Finally, the process ends with block 816, in which the browser 22 clears all of the “need lookup” flags to prevent any further searching (which would be fruitless).

As can be seen from FIG. 8A, the next search request to the database server will be triggered by a new telephone number entry into the contact database 24 or the use (inbound or outbound) of a telephone number that is in the contact database but has no associated name or address data.

As can be seen, the above described processes enable a user's contact database to be incrementally and automatically populated each time the user places or receives a call using the wireless handset. These processes, therefore, make the contact database feature of a wireless handset more usable for many users.

FIG. 9 shows an abstraction of a processing system that may represent any of the processing devices or systems shown in FIG. 1 (i.e., a mobile device 1, proxy gateway 4, or a server 5). The illustrated system includes one or more processors 91, i.e. a central processing unit (CPU), read-only memory (ROM) 92, and random access memory (RAM) 93, which may be coupled to each other by a bus system 97. The processor(s) 91 may be, or may include, one or more programmable general-purpose or special-purpose microprocessors, digital signal processors (DSPs), programmable controllers, application specific integrated circuits (ASICs), programmable logic devices (PLDs), or a combination of such devices. The bus system 97 includes one or more buses or other connections, which may be connected to each other through various bridges, controllers and/or adapters, such as are well-known in the art. For example, the bus system 97 may include a “system bus”, which may be connected through one or more adapters to one or more expansion buses, such as a Peripheral Component Interconnect (PCI) bus, HyperTransport or industry standard architecture (ISA) bus, small computer system interface (SCSI) bus, universal serial bus (USB), or Institute of Electrical and Electronics Engineers (IEEE) standard 1394 bus (sometimes referred to as “Firewire”).

Also coupled to the bus system 97 are one or more mass storage devices 94, input/output (I/O) devices 95, and data communication devices 96. Each mass storage device 94 may be, or may include, any one or more devices suitable for storing large volumes of data in a non-volatile manner, such as a magnetic disk or tape, magneto-optical (MO) storage device, or any of various forms of Digital Versatile Disk (DVD) or Compact Disk (CD) based storage, or a combination thereof.

Each data communication device 96 is a device suitable for enabling the processing system to communicate with remote devices and may be, for example, a wireless transceiver (e.g., in the case of a mobile device), a conventional modem, a Digital Subscriber Line (DSL) modem, a cable modem, an Ethernet adapter, an Integrated Services Digital Network (ISDN) adapter, a satellite transceiver, or the like. The I/O device(s) 95 may include, for example, a keyboard or keypad, a display device, and a pointing device (e.g., a mouse, trackball, or touchpad). Note, however, that such I/O devices may be unnecessary for certain devices and/or in certain embodiments. For example, a device which functions purely as a server does not necessarily require local I/O devices in addition to a data communication device, particularly if the server is not intended to directly interface with a user or operator. Similarly, it may not be desirable (or practical) to equip a mobile device with a mass storage device. Many other variations on the above described embodiment are possible. Further, it will be understood that the processing system may include other conventional components such as are well-known in the art (e.g., RF signal processing circuitry in the case of a mobile device 1).

The processes described above may be implemented in software 98, which may reside, either partially or completely, in any of RAM 93, mass storage device 94 and/or ROM 92, as shown, or on a remote processing system.

Thus, a method and apparatus for automatically populating a contact database in a mobile communication device have been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

What is claimed is:

1. A method of automatically populating a contact database in a mobile communication device configured to communicate voice and data over a wireless network, the method comprising:
receiving a telephone number associated with a voice call involving the mobile communication device; and
when a data connection is established between the mobile communication device and a remote processing system via the wireless network, then automatically
obtaining data associated with the telephone number via the wireless network, and
storing the data in the contact database in association with the telephone number.

2. A method as recited in claim 1, wherein said receiving the telephone number comprises receiving Caller-ID information including the telephone number and associated with an incoming call to the mobile communication device.

3. A method as recited in claim 1, wherein said receiving the telephone number comprises receiving a telephone number associated with an outgoing call being placed by a user of the mobile communication device.

4. A method as recited in claim 1, further comprising attempting to locate the data associated with the telephone number in the contact database, wherein said obtaining data associated with the telephone number via the wireless network is performed only after failing to locate the in the contact database.

5. A method as recited in claim 1, wherein the mobile communication device comprises a browser to allow a user of the mobile communication device to navigate hypermedia information, and wherein said obtaining the data associated with the telephone number via the wireless network is done automatically by the browser.

6. A method as recited in claim 1, wherein said obtaining the data associated with the telephone number comprises automatically requesting the data associated with the telephone number from a remote server via the wireless network when the data connection is established.

7. A method as recited in claim 1, wherein the obtained data associated with the telephone number is contained in a vCard.

8. A method as recited in claim 1, wherein the obtained data associated with the telephone number comprises name or address information associated with the telephone number.

9. A method as recited in claim 1, wherein the obtained data associated with the telephone number comprises ring tone data for use to generate a ring tone indicating the incoming voice call.

10. A method of operating a browser in a mobile communication device configured to communicate voice and data over a wireless network, the browser to enable a user of the mobile communication device to access and navigate hypermedia data, the method comprising:
receiving a telephone number at the browser in response to the mobile communication device receiving or initiating a voice call over the wireless network;
in response to receiving the telephone number, automatically determining whether data of a predetermined type associated with the telephone number is stored in a contact database in the mobile communication device;
if the data associated with the telephone number is not stored in the contact database, then
waiting to establish a data connection with a remote server via the wireless network, and when the data connection is established,
automatically requesting the data associated with the telephone number from the remote server via the wireless network,
receiving the data associated with the telephone number via the wireless network, and
storing the data associated with the telephone number in the contact database in association with the telephone number.

11. A method as recited in claim 10, wherein said receiving the telephone number comprises receiving Caller-ID information including the telephone number and associated with an incoming call to the mobile communication device.

12. A method as recited in claim 10, wherein said receiving the telephone number comprises receiving a telephone number associated with an outgoing call being placed by a user of the mobile communication device.

13. A method as recited in claim 10, wherein the received data associated with the telephone number is contained in a vCard.

14. A method as recited in claim 10, wherein the received data associated with the telephone number comprises name or address information associated with the telephone number.

15. A method as recited in claim 10, wherein the received data associated with the telephone number comprises ring tone data for use to generate a ring tone indicating the incoming voice call.

16. A machine-readable program storage medium storing instructions for execution in a mobile communication device configured to communicate voice and data over a wireless network, to cause the mobile communication device to execute a process of automatically populating a contact database in the mobile communication device, the process comprising:
receiving a telephone number associated with a voice call involving the mobile communication device; and
when a data connection is established between the mobile communication device and a remote processing system via the wireless network, then automatically
obtaining data associated with the telephone number via the wireless network, and
storing the data in the contact database in association with the telephone number.

17. A machine-readable program storage medium as recited in claim 16, wherein said receiving the telephone number comprises receiving Caller-ID information including the telephone number and associated with an incoming call to the mobile communication device.

18. A machine-readable program storage medium as recited in claim 16, wherein said receiving the telephone number comprises receiving a telephone number associated with an outgoing call being placed by a user of the mobile communication device.

19. A machine-readable program storage medium as recited in claim 16, wherein the process further comprises attempting to locate the data associated with the telephone number in the contact database, wherein said obtaining data associated with the telephone number via the wireless network is performed only after failing to locate the in the contact database.

20. A machine-readable program storage medium as recited in claim 16, wherein the instructions are part of a browser to allow a user of the mobile communication device to navigate hypermedia information, and wherein said obtaining the data associated with the telephone number via the wireless network is done automatically by the browser.

21. A machine-readable program storage medium as recited in claim 16, wherein said obtaining the data associated with the telephone number comprises automatically requesting the data associated with the telephone number from a remote server via the wireless network when the data connection is established.

22. A machine-readable program storage medium as recited in claim 16, wherein the obtained data associated with the telephone number is contained in a vCard.

23. A machine-readable program storage medium as recited in claim 16, wherein the obtained data associated with the telephone number comprises name or address information associated with the telephone number.

24. A machine-readable program storage medium as recited in claim 16, wherein the obtained data associated with the telephone number comprises ring tone data for use to generate a ring tone indicating the incoming voice call.

25. A mobile communication device comprising:
a telephony unit to communicate voice over a wireless network; and
a browser to allow a user of the mobile communication device to browse hypermedia information via the wireless network, the browser providing a process of automatically populating a contact database in the mobile communication device, the process comprising:
receiving from the telephony unit a telephone number associated with a voice call involving the mobile communication device, and
when a data connection is established between the mobile communication device and a remote processing system via the wireless network, then automatically
obtaining data associated with the telephone number via the wireless network, and
storing the data in the contact database in association with the telephone number.

26. A mobile communication device as recited in claim 25, wherein said receiving from the telephony unit the telephone number comprises receiving Caller-ID information including the telephone number and associated with an incoming call to the mobile communication device.

27. A mobile communication device as recited in claim 25, wherein said receiving the telephone number comprises receiving from the telephony unit a telephone number associated with an outgoing call being placed by a user of the mobile communication device.

28. A mobile communication device as recited in claim 25, wherein the process further comprises attempting to locate the data associated with the telephone number in the contact database, wherein said obtaining data associated with the telephone number via the wireless network is performed only after failing to locate the in the contact database.

29. A mobile communication device as recited in claim 25, wherein the instructions are part of a browser to allow a user of the mobile communication device to navigate hypermedia information, and wherein said obtaining the data associated with the telephone number via the wireless network is done automatically by the browser.

30. A mobile communication device as recited in claim 25, wherein said obtaining the data associated with the telephone number comprises automatically requesting the data associated with the telephone number from a remote server via the wireless network when the data connection is established.

31. A mobile communication device as recited in claim 25, wherein the obtained data associated with the telephone number is contained in a vCard.

32. A mobile communication device as recited in claim 25, wherein the obtained data associated with the telephone number comprises name or address information associated with the telephone number.

33. A mobile communication device as recited in claim 25, wherein the obtained data associated with the telephone number comprises ring tone data for use to generate a ring tone indicating the incoming voice call.
